(19) United States
(12) Patent Application Publication
(10) Pub. No.: US 2018/0330546 A1
(43) Pub. Date: Nov. 15, 2018

(54) WIND RENDERING FOR VIRTUAL REALITY COMPUTING DEVICE

(71) Applicant: Microsoft Technology Licensing, LLC, Redmond, WA (US)

(72) Inventors: Robert FERRESE, Redmond, WA (US); Gregory Bishop BAHM, Kirkland, WA (US)

(73) Assignee: Microsoft Technology Licensing, LLC, Redmond, WA (US)

(21) Appl. No.: 15/811,532

(22) Filed: Nov. 13, 2017

Related U.S. Application Data
(60) Provisional application No. 62/503,861, filed on May 9, 2017.

(51) Int. Cl. G06T 19/00; A63F 13/65; G02B 27/00; G02B 27/01; H04N 13/04

(52) U.S. Cl. CPC G06T 19/006; A63F 13/65; H04N 13/044; G02B 27/017; G02B 27/0093

(57) ABSTRACT

A method for rendering wind data includes receiving wind data representing real or simulated wind conditions of a wind source environment. The wind data is mapped to a plurality of locations within a virtual environment displayed by a virtual reality computing device to a user. A position and a gaze vector of the user are determined. Based on the position and gaze vector, wind diversity locations within the virtual environment are identified where parameters of wind data mapped to the wind diversity locations differ from parameters of wind data mapped to other locations in the virtual environment by more than a threshold. The wind data is rendered within the virtual environment as a plurality of visible wind representations, such that a differential wind effect is applied to visible wind representations rendered at the wind diversity locations.

### CROSS REFERENCE TO RELATED APPLICATIONS

This application claims priority to U.S. Provisional Patent Application No. 62/503,861, filed May 9, 2017, the entirety of which is hereby incorporated herein by reference.

### BACKGROUND

Augmented/virtual reality computing devices can be used to provide augmented reality (AR) experiences and/or virtual reality (VR) experiences by presenting virtual imagery to a user. Such devices are frequently implemented as head-mounted display devices (HMDs). Virtual imagery can take the form of one or more virtual shapes, objects, or other visual phenomena that are presented such that they appear as though they are physically present in the real world.

### BRIEF DESCRIPTION OF THE DRAWINGS

FIG. 1 schematically shows a user viewing a virtual environment displayed by a virtual reality computing device.

FIGS. 2A and 2B schematically illustrate presentation of virtual imagery to a user of a virtual reality computing device.

FIG. 3 illustrates an example method for rendering wind data.

FIG. 4 schematically illustrates receipt of wind data by a virtual reality computing device.

FIG. 5 schematically illustrates mapping of wind data to a plurality of locations within a virtual environment.

FIGS. 6A and 6B schematically illustrate identification of wind diversity locations based on position and gaze vector of a user.

FIG. 7 schematically illustrates rendering wind data as a plurality of visible wind representations.

FIG. 8 schematically shows an example virtual reality computing device.

FIG. 9 schematically shows an example computing system.

### DETAILED DESCRIPTION

Augmented/virtual reality computing devices can be used to visualize complex systems and data in three-dimensions. As an example, augmented/virtual reality computing devices can be used to visualize weather data, including how wind currents interact with each other and flow through an environment. Existing solutions for visualizing wind data are frequently constrained to “top-down” views of wind currents in a region, or volumetric “blobs” that can only be viewed as two-dimensional “slices” at different depths. These solutions do not enable a user to view how wind patterns behave at arbitrary three-dimensional positions within the environment itself, and make it difficult for the user to distinguish between less-interesting homogenous wind patterns and more-interesting heterogenous wind patterns.

Accordingly, the present disclosure is directed to a technique for rendering and visualizing wind data in a virtual environment. According to this technique, a virtual reality computing device receives wind data, and maps the wind data to locations in a virtual environment. The virtual reality computing device then identifies “wind diversity locations” in the virtual environment that correspond to more heterogenous or “interesting” wind patterns, which may be identified by analyzing any of a variety of parameters associated with wind data mapped to different locations. These identified locations may represent parts of the environment where wind currents diverge in different directions, come together as a swirl or eddy, have significantly different speeds as compared to nearby wind currents, etc. When the wind data is rendered for viewing, a differential wind effect is applied to visible wind representations at the identified wind diversity locations, making it easier for a user to distinguish interesting wind patterns from less-interesting patterns. In some cases, the user's position and gaze vector may be considered when identifying wind diversity locations and rendering wind data, allowing the user to review a virtual environment tailored to their unique point-of-view.

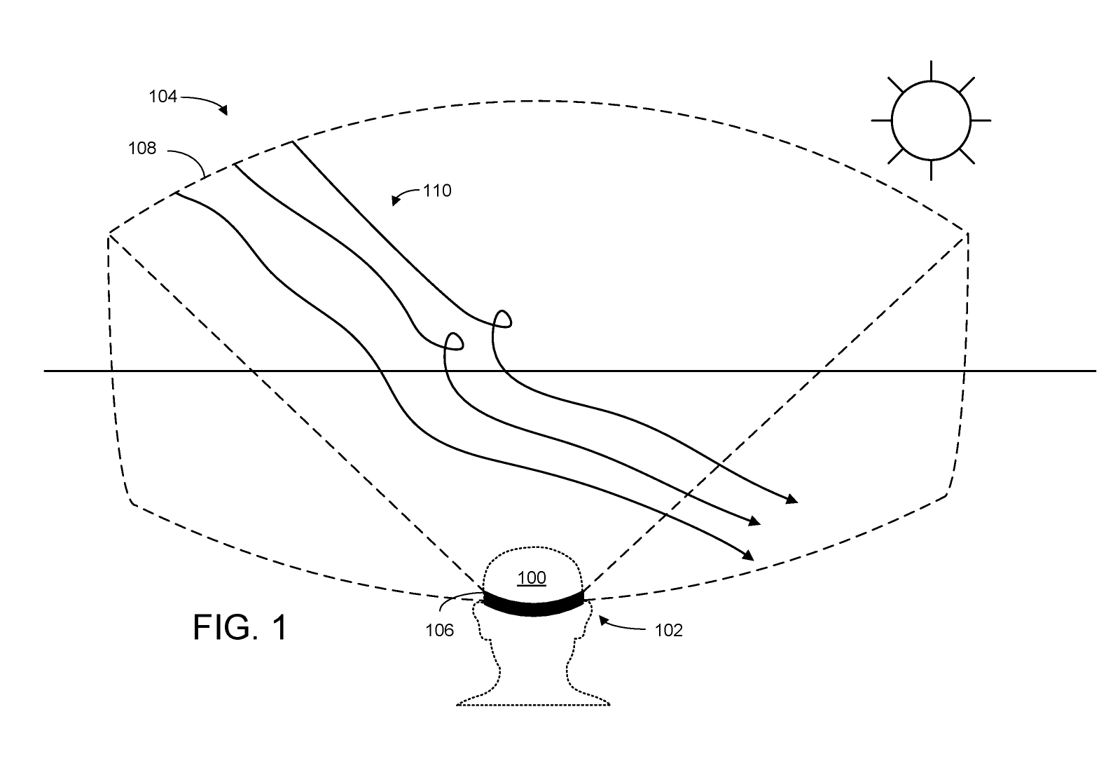

FIG. 1 schematically shows a user 100 wearing a virtual reality computing device 102 and viewing a surrounding environment 104. Virtual reality computing device 102 includes one or more near-eye displays 106 configured to present virtual imagery to eyes of the user, as will be described below. FIG. 1 also shows a field of view (FOV) 108 of the user, indicating the area of environment 104 visible to user 100 from the illustrated vantage point.

In the illustrated example, virtual reality computing device 102 is an augmented reality computing device that allows user 100 to directly view a real-world environment through a partially or fully transparent near-eye display. However, in other examples, a virtual reality computing device may be fully opaque and either present imagery of a real-world environment as captured by a front-facing camera, or present a fully virtual surrounding environment. Accordingly, a “virtual environment” may refer to a fully-virtualized experience in which the user's surroundings are replaced by virtual objects and imagery, and/or an augmented reality experience in which virtual imagery is visible alongside or superimposed over physical objects in the real world. To avoid repetition, experiences provided by both implementations are referred to as “virtual reality” and the computing devices used to provide the augmented or purely virtualized experiences are referred to as “virtual reality computing devices.”

Virtual reality computing device 102 may be used to view and interact with a variety of virtual objects and/or other virtual imagery. Such virtual imagery may be presented on the near-eye displays as a series of digital image frames that dynamically update as the virtual imagery moves and/or a six degree-of-freedom (6-DOF) pose of the virtual reality computing device changes.

Specifically, FIG. 1 shows virtual wind representations 110 being presented to the user as part of a virtual reality environment. As shown, wind representations 110 start at the edge of FOV 108, indicating that they are only visible within FOV 108 via near-eye displays 106. It will be understood that the virtual wind representations are a non-limiting example of virtual imagery that may be rendered and displayed by a virtual reality application.

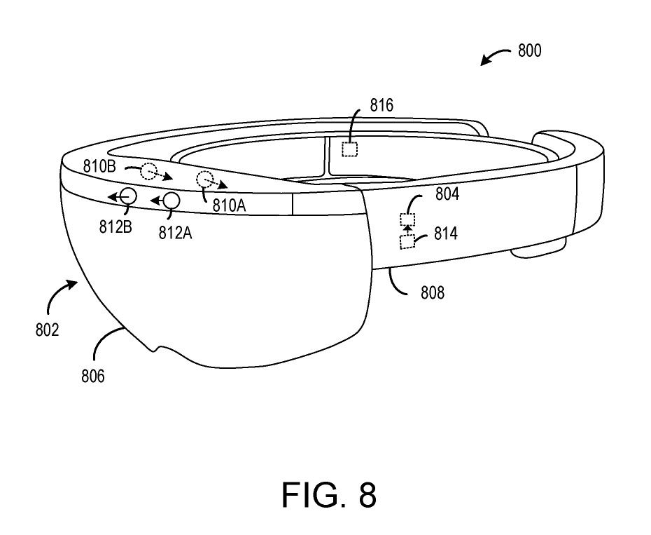

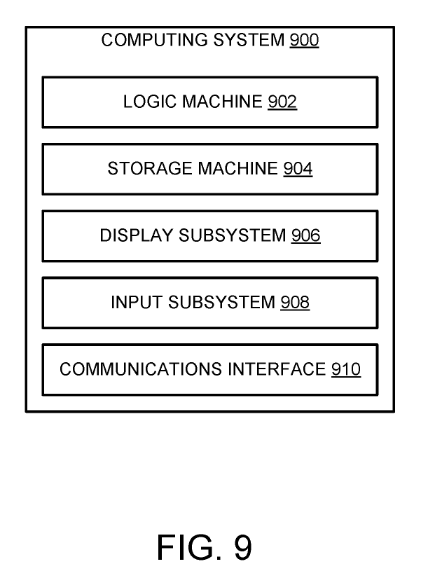

Though the term “virtual reality computing device” is generally used herein to describe a head-mounted display device (HMD) including one or more near-eye displays, devices having other form factors may instead be used to view and manipulate virtual imagery. For example, virtual imagery may be presented and manipulated via a smartphone or tablet computer facilitating an augmented or virtual reality experience, and/or other suitable computing devices may instead be used. Virtual reality computing device 102 may be implemented as the virtual reality computing system 800 shown in FIG. 8, and/or the computing system 900 shown in FIG. 9.

As used herein, “virtual reality application” will refer to any software running on a virtual reality computing device and associated with a virtual reality experience. Such software may be preinstalled on the virtual reality computing device, for example as part of the operating system, and/or such software may be user-installable. Examples of virtual reality applications may include games, interactive animations or other visual content, productivity applications, system menus, etc.

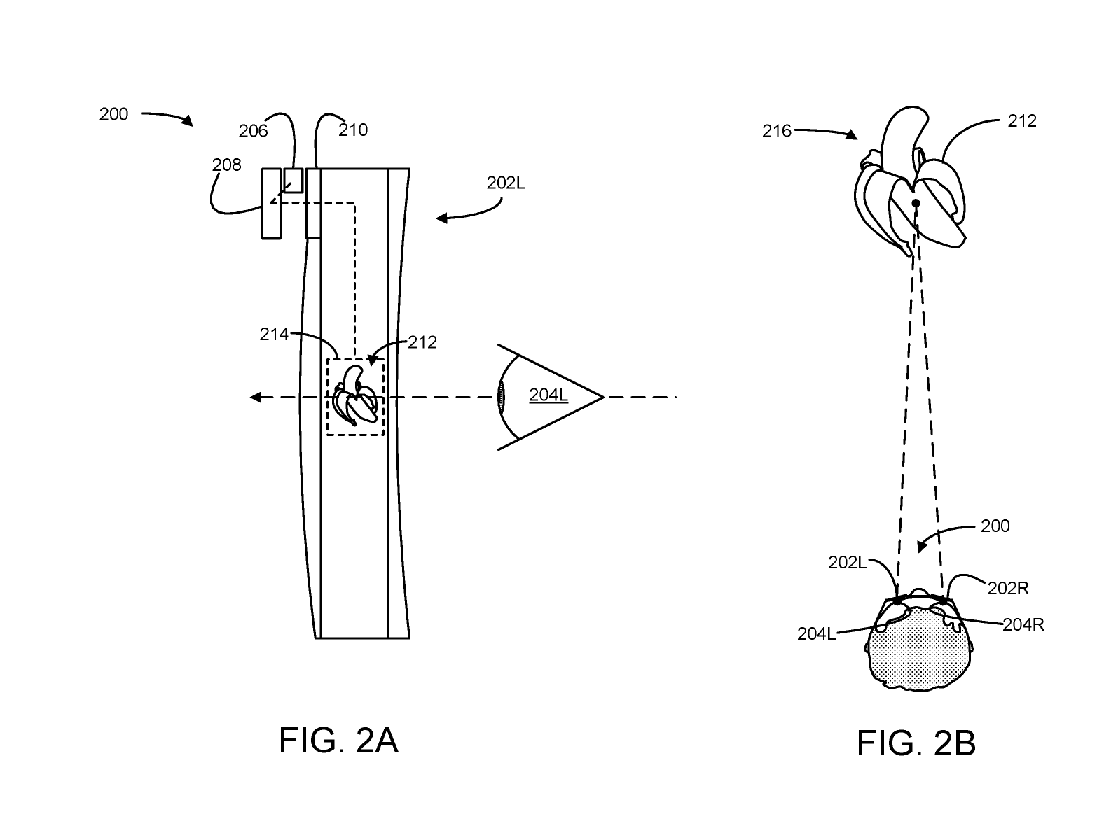

Virtual imagery, such as virtual wind representations 110, may be displayed to a user in a variety of ways and using a variety of suitable technologies. For example, in some implementations, the near-eye display associated with a virtual reality computing device may include two or more microprojectors, each configured to project light on or within the near-eye display. FIG. 2A shows a portion of an example near-eye display 200. Near-eye display 200 includes a left microprojector 202L situated in front of a user's left eye 204L. It will be appreciated that near-eye display 200 also includes a right microprojector 202R situated in front of the user's right eye 204R, not visible in FIG. 2A.

The near-eye display includes a light source 206 and a liquid-crystal-on-silicon (LCOS) array 208. The light source may include an ensemble of light-emitting diodes (LEDs)—e.g., white LEDs or a distribution of red, green, and blue LEDs. The light source may be situated to direct its emission onto the LCOS array, which is configured to form a display image based on control signals received from a logic machine associated with a virtual reality computing device. The LCOS array may include numerous individually addressable display pixels arranged on a rectangular grid or other geometry, each of which is usable to show an image pixel of a display image. In some embodiments, pixels reflecting red light may be juxtaposed in the array to pixels reflecting green and blue light, so that the LCOS array forms a color image. In other embodiments, a digital micromirror array may be used in lieu of the LCOS array, or an active-matrix LED array may be used instead. In still other embodiments, transmissive, backlit LCD or scanned-beam technology may be used to form the display image.

In some embodiments, the display image from LCOS array 208 may not be suitable for direct viewing by the user of near-eye display 200. In particular, the display image may be offset from the user's eye, may have an undesirable vergence, and/or a very small exit pupil (i.e., area of release of display light, not to be confused with the user's anatomical pupil). In view of these issues, the display image from the LCOS array may be further conditioned en route to the user's eye. For example, light from the LCOS array may pass through one or more lenses, such as lens 210, or other optical components of near-eye display 200, in order to reduce any offsets, adjust vergence, expand the exit pupil, etc.

Light projected by each microprojector 202 may take the form of imagery visible to a user, occupying a particular screen-space position relative to the near-eye display. As shown, light from LCOS array 208 is forming virtual imagery 212 at screen-space position 214. Specifically, virtual imagery 212 is a banana, though any other virtual imagery may be displayed. A similar image may be formed by microprojector 202R, and occupy a similar screen-space position relative to the user's right eye. In some implementations, these two images may be offset from each other in such a way that they are interpreted by the user's visual cortex as a single, three-dimensional image. Accordingly, the user may perceive the images projected by the microprojectors as a three-dimensional object occupying a three-dimensional world-space position that is behind the screen-space position at which the virtual imagery is presented by the near-eye display.

This is shown in FIG. 2B, which shows an overhead view of a user wearing near-eye display 200. As shown, left microprojector 202L is positioned in front of the user's left eye 204L, and right microprojector 202R is positioned in front of the user's right eye 204R. Virtual imagery 212 is visible to the user as a virtual object present at a three-dimensional world-space position 216. In some cases, the user may move the virtual object such that it appears to occupy a different three-dimensional position. Additionally, or alternatively, movement of the user may cause a pose of the virtual reality computing device to change. In response, the virtual reality computing device may use different display pixels to present the virtual object so as to give the illusion that the virtual object has not moved relative to the user.

Returning briefly to FIG. 1, in some examples, wind representations 110 may rendered from a set of wind data that describes actual wind conditions in a particular environment. This environment may correspond to the current real-world environment of the virtual reality computing device (i.e., surrounding environment 104), or a different real-world environment. In other examples, wind representations 110 may be rendered from wind data that does not correspond to any particular real-world location, but rather is generated by a virtual reality application, such as a video game or interactive animation. Regardless, specific data points of the wind data can be mapped to locations within a three-dimensional virtual environment generated by the virtual reality computing device. Virtual imagery corresponding to the wind representations can then be displayed at specific screen-space positions on near-eye displays of the virtual reality computing device, thereby creating the illusion that the wind representations are present at world-space positions within the virtual environment.

In FIG. 1, virtual wind representations 110 are shown as solid lines, with arrows indicating wind flow direction. While effective at illustrating individual wind currents, using this arrow motif to represent larger wind patterns and/or wind patterns in larger environments can have drawbacks. For example, when wind conditions near the user are relatively homogeneous, more interesting wind patterns further away from the user can be occluded by uninteresting arrow-type representations in the foreground. Furthermore, virtual reality computing devices will typically render the underlying wind data in substantially the same way regardless of the user's position and gaze direction. This can also result in the user being provided with a sub-optimal or undesirable view of the wind representations, for example when the user's entire view is taken up by a representation of a single wind current blowing directly toward their position.

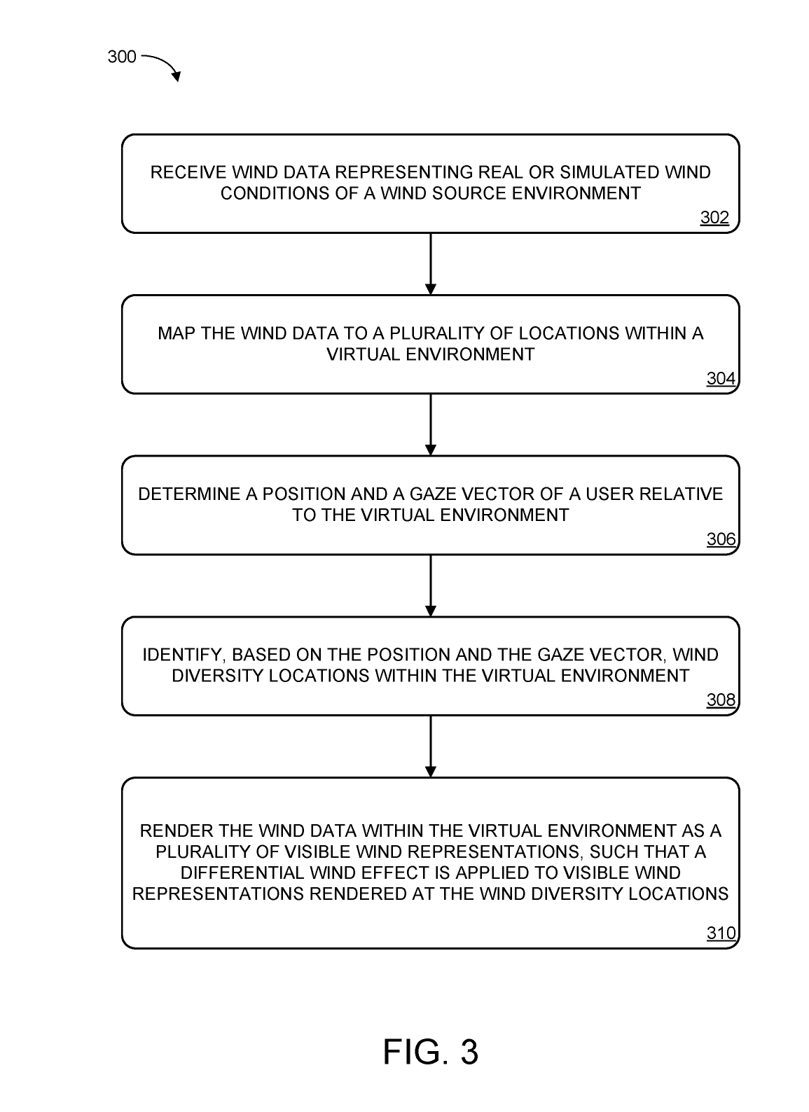

Accordingly, FIG. 3 illustrates an example method 300 for rendering wind data in a virtual environment. It will be understood that, while method 300 will typically be performed by a virtual reality computing device as described above, in other examples method 300 may be performed by any suitable computing device having any suitable hardware and form factor. In some examples, method 300 may be implemented on virtual reality computing device 800 described below with respect to FIG. 8 and/or computing system 900 described below with respect to FIG. 9.

At 302, method 300 includes receiving wind data representing real or simulated wind conditions of a wind source environment. The term “wind data” is used herein to generally refer to any computer dataset or data structure that is useable to recreate or represent (e.g., via visual display) at least one wind current or pattern, whether that wind is real or simulated. It will be understood that such a computer dataset or structure can take any suitable form, can be packaged or encoded in any suitable way, can include any suitable variables or parameters, and can have any suitable resolution or fidelity. In a typical example, wind data will include information regarding wind conditions at specific three-dimensional positions within a real or simulated environment. In other words, the wind data may take the form of a cluster of individual data points, each data point conveying the speed and direction of real or simulated air movement at a distinct three-dimensional location (i.e., the data points may be expressed as vectors that are dispersed throughout three-dimensional space). The resolution of the wind data can therefore be increased or decreased by increasing or decreasing the total number of wind data points, thereby increasing or decreasing the spacing between the three-dimensional positions that the various data points describe. However, in other examples, the wind data points may take other suitable forms.

In many cases, the wind source environment described by the wind data will be an environment in the real world. In one example, the wind source environment may be a current real-world environment of the user of the virtual reality computing device. In other words, the virtual reality computing device may receive and render wind data describing wind conditions in its own local environment, provided such wind data is available. This would allow the user to visualize real surrounding wind currents and patterns, potentially in an augmented reality scenario, for example. Alternatively, in other examples, the wind source environment could be any other suitable environment in the real world. For example, the virtual reality computing device may receive wind data describing wind conditions at a user-specified location (e.g., the user's home or a region of interest), a location experiencing unusual or noteworthy weather conditions (ₑ._{g}., ₐ hurricane or tornado), a user's future route (e.g., wind conditions along the anticipated path of an airplane or sailboat), etc. It will be understood that the wind source environment need not even be an environment on Earth. For example, wind data received by a virtual reality computing device could in some examples describe wind conditions on other planets or celestial bodies, for instance allowing the user to visualize wind currents on Jupiter or dust storms on Mars.

The wind source environment may alternatively be a simulated environment. For example, as discussed above, a virtual reality computing device may render virtual imagery that appears, from the user's perspective, to replace the user's surrounding environment, thereby providing the illusion that the user has been transported to a different place. As examples, the user may be presented with a virtual environment intended to mimic or recreate a real-world environment (e.g., a monument or landmark), or a fictional environment rendered as part of a video game or other immersive experience. In situations where the virtual environment generated by the virtual reality computing device has virtual wind conditions, such wind conditions may be rendered as described herein, regardless of the fact that they do not correspond to actual airflow in a real-world environment. In a specific example, a virtual reality computing device may execute a video game application, and in the process, present the user with virtual imagery that gives the illusion that the user is standing on a sailboat in the middle of an ocean. To navigate their virtual sailboat across the virtual ocean, the user may find it beneficial to visualize the simulated wind conditions of their virtual environment as described herein.

It will be understood that the wind data itself may be collected or generated in any suitable way, and provided by any suitable source. When the wind data represents wind conditions in a real-world environment, the wind data will generally be collected by physical hardware sensors present in or near the real-world environment. Such sensors can include, for example, windmills, weather vanes, cameras, microphones, heat sensors, etc. The wind data may be collected and distributed by, for example, a weather service or other network-accessible source of wind information, and/or collected directly from the sensors by the virtual reality computing device. In cases where the wind data represents simulated wind conditions, then the wind data will generally originate from the execution of computer code, whether that execution is performed by the virtual reality computing device, or another suitable computing device that is communicatively coupled with the virtual reality computing device.

Furthermore, it will be understood that the wind data need not represent live weather conditions. In some scenarios, the wind data may represent historical wind conditions, and/or may represent anticipated future wind conditions, in addition to or as an alternative to representing wind conditions that are currently present in an environment.

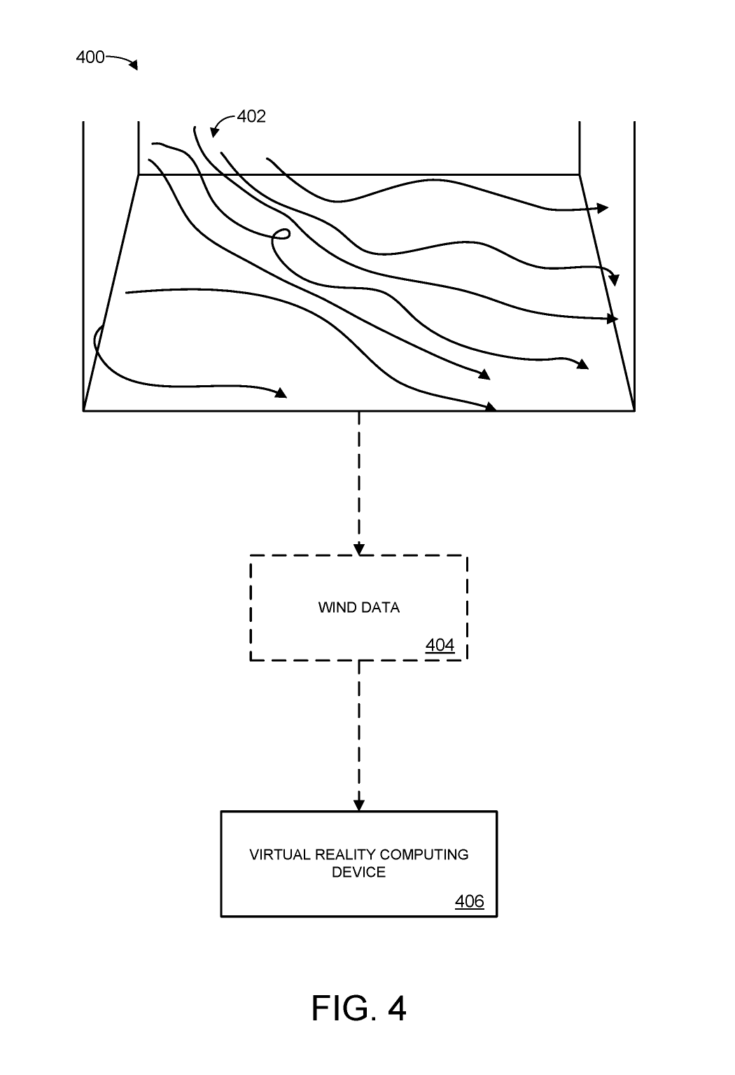

Receipt of wind data by a virtual reality computing device is schematically illustrated in FIG. 4. Specifically, FIG. 4 shows a representation of a wind source environment 400, which in this example is a real-world environment. FIG. 4 also shows multiple wind currents 402 present in wind source environment 400. Based on these wind currents, a set of wind data 404 is generated that represents the wind currents. Because the wind source environment is a real-world environment, the wind data will typically be collected by one or more hardware sensors monitoring environment 400. As discussed above, such sensors may be maintained by any suitable party, such as a weather service or an owner/user of the virtual reality computing device. Wind data 404 is received by a virtual reality computing device 406. As discussed above, the wind data may be received either via direct communication with the sensors monitoring the wind source environment, or via a suitable network-accessible source of wind data. In a typical example, the wind data will be received over the Internet from a server computer associated with a weather monitoring service. Any storage and/or communication mechanism may be employed to provide the wind data to the virtual reality computing device.

Returning to FIG. 3, method 300 includes, at 304, mapping the wind data to a plurality of locations within a virtual environment. In other words, once wind data is received by the virtual reality computing device, it can be mapped to a virtual environment generated and/or displayed by the virtual reality computing device. In general, regardless of whether an augmented or virtual reality experience is provided, the virtual reality computing device will maintain its own internal coordinate system that it uses to localize and track the positions of both real-world objects and virtual imagery relative to the position of the virtual reality computing device and/or the surrounding real-world environment. In this manner, the virtual reality computing device can provide realistic and immersive experiences that take advantage of the available real-world space. For example, in an augmented reality scenario, the virtual reality computing device may position a virtual object such that it appears to be attached to a wall in the real-world. Similarly, the virtual reality computing device can display virtual objects that appear to occupy a fixed position in three-dimensional space, or appear to maintain a constant position relative to the user of the virtual reality computing device, even as the three-dimensional position/pose of the virtual reality computing device changes.

Because individual data points of the wind data will typically be associated with discrete three-dimensional locations in the wind source environment, mapping the wind data to locations within the virtual environment may include reconciling a coordinate system employed by the wind data with the coordinate system used by the virtual reality computing device. In cases where the wind data corresponds to actual wind patterns in the local environment of the virtual reality computing device, wind data points can be mapped to virtual locations corresponding to the real-world locations of the actual wind currents they are associated with. In cases where the wind data represents simulated wind in a simulated environment, it is likely that the wind data already shares a common coordinate system with the virtual reality computing device, in which case mapping can occur with little to no need for reconciliation of coordinate systems.

In cases where the wind source environment is a non-local real-world environment, any suitable method may be used to map the wind data to locations within the virtual environment. As an example, the position of the virtual reality computing device may be defined as the center of the virtual environment, with the wind data being mapped to locations surrounding this center position. In other cases, the position of the virtual reality computing device may be defined as the edge of the virtual environment, such that the user can see most or all of the virtual environment by gazing forward. In some examples, cardinal directions may be preserved between the wind source environment and virtual environment. In some cases, the wind source environment and virtual environment may be the same size. In this case, the distance between positions associated with wind data points in the wind source environment may be preserved by the mapped locations of those same wind data points in the virtual environment. In other cases, however, the sizes of the wind source environment and virtual environment may differ, which may result in the distances between adjacent wind data points being scaled up or down during mapping. In an example scenario, the virtual environment may be smaller than the wind source environment. This can, for example, allow the user to visualize relatively large weather patterns (e.g., storm systems) in a relatively small area.

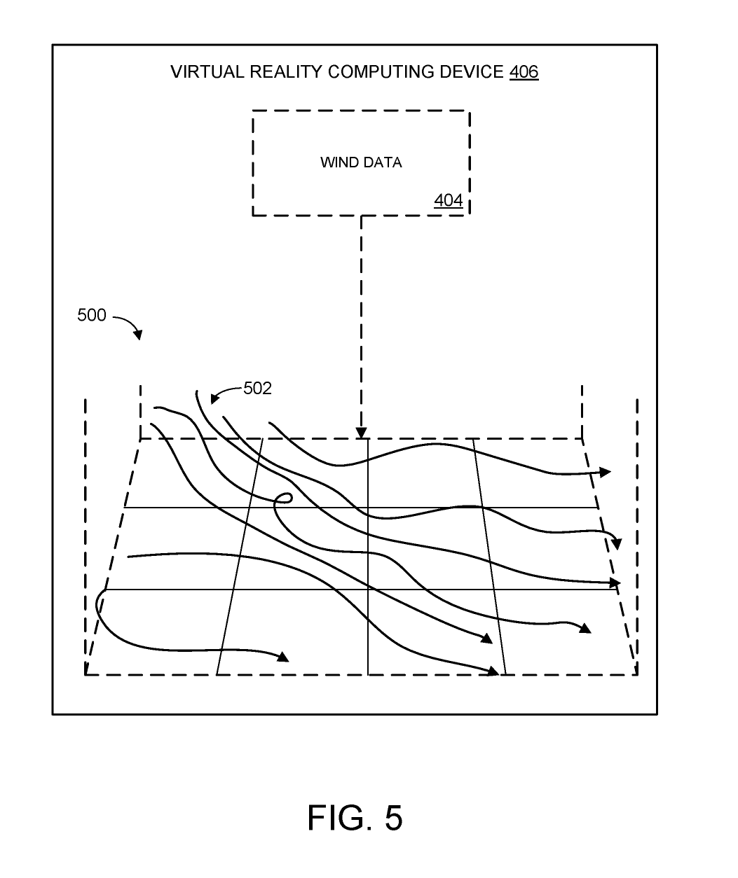

Mapping of wind data is schematically illustrated in FIG. 5. As shown, wind data 404 is mapped to a virtual environment 500 by virtual reality computing device 406. Representations 502 of wind currents from the wind source environment are mapped to locations within the virtual environment that correspond to the actual positions of wind currents 402 within wind source environment 400 of FIG. 4. As discussed above, this may be done on the basis of a coordinate system maintained by the virtual reality computing device, represented in FIG. 5 as the gridlines visible within virtual environment 500. It will be understood that virtual environment 500 and representations 502 of wind currents are presented as visual aids for the purpose of explaining mapping of wind data, and do not represent actual virtual imagery presented to the user via the display of the virtual reality computing device.

Returning to FIG. 3, at 306, method 300 includes determining a position and a gaze vector of the user relative to the virtual reality environment. This may be done in a variety of suitable ways. As will be described below with respect to FIG. 8, a virtual reality computing device may include a variety of inward and outward-facing image sensors, which may be used to identify and track a gaze vector of a user. The virtual reality computing device may additionally or alternatively include any number of suitable movement/position sensors, including an inertial measurement unit (IMU) configured to determine a three-dimensional position, or “pose,” of the virtual reality computing device. With this information, the virtual reality computing device can pinpoint the location of the user relative to the wind data points mapped to the virtual environment, as well as determine the direction of the user's gaze.

Continuing with FIG. 3, at 308, method 300 includes identifying, based on the position and the gaze vector of the user, wind diversity locations within the virtual environment. This may include identifying any locations, either within the entire virtual environment or within the user's current FOV (given by the user's position and gaze vector) where one or more parameters of the wind data differ from parameters of wind data mapped to other locations in the virtual environment by more than a threshold. As examples, such parameters can include wind speed and direction. In an example scenario, wind data points can be assigned heterogeneity scores indicating the extent to which the speed and/or direction of each wind data point differs from neighboring wind data points, and/or an average speed/direction of all wind data points in the environment. For example, a wind data point associated with a similar wind speed and direction as neighboring wind data points will have a relatively low heterogeneity score. In contrast, a wind data point associated with a significantly different speed and/or direction as compared to nearby wind data points will have a relatively high heterogeneity score. In some examples, any location within the virtual environment and/or the user's current FOV associated with a wind data point having a heterogeneity score exceeding a threshold may be identified as a wind diversity location. In other examples, wind diversity locations may be any locations within the virtual environment and/or user's FOV having a minimum density or concentration of wind data points exceeding the threshold.

In some cases, the threshold and/or specific parameters used to identify wind diversity locations may be specified by the user. For example, when the user is interested in visualizing more or less granular differences between wind patterns at various locations within the virtual environment, the user may increase or decrease the threshold by which wind diversity locations are identified. Similarly, when the user is more interested in specific variations in the wind data (e.g., if the user finds wind speed or directionality differences more interesting), the user may adjust the parameters used to identify the wind diversity locations. In the example given above, the user may change how heterogeneity scores are calculated to incorporate only wind speed or directionality, or change how wind speed and directionality differences are weighted when calculating heterogeneity scores.

Furthermore, as discussed above, identification of wind diversity locations may be based at least in part on a current position and gaze vector of the user relative to the virtual environment. For example, in many situations, the user may not have a complete view of the entire virtual environment, for instance because parts of the virtual environment are out of the user's FOV or occluded by real or virtual objects. Accordingly, when identifying wind diversity locations, the virtual reality computing device may focus on parts of the virtual environment that are currently visible to the user, thereby deprioritizing or ignoring potentially interesting wind patterns not currently visible to the user. This can potentially conserve processing resources of the virtual reality computing device, allowing the virtual reality computing device to devote the bulk of its efforts in displaying portions of the virtual environment that are currently visible.

In further examples, the user may have a gaze vector “looking in” to a high-speed wind current coming directly toward the user. While this may be interesting from the user's perspective, it may nonetheless obscure the user's view of other interesting wind patterns elsewhere in the virtual environment. In a specific example, the area directly in front of the user may be dominated with relatively homogeneous, or “uninteresting” wind patterns, which as discussed above, can obstruct the user's view of more interesting wind patterns elsewhere in the environment. Accordingly, in some cases, identification of wind diversity locations may be based at least in part on the distance between the user's current position and the wind diversity locations. For example, locations further away from the user may be more likely to be identified as wind diversity locations than locations closer to the user. This can help the user to more comprehensively review the entire virtual environment at once, at the expense of viewing wind conditions directly in front of the user, which are therefore less likely to obstruct the user's view.

Similar problems may arise when the user is moving or changing their gaze direction. For instance, while a user is stationary, a wind current having a high speed and a particular direction may be interesting. However, if the user begins moving at the same speed and at the same direction as the wind current, it may be less interesting or noteworthy than pockets of relatively motionless air, or fast air that is moving in a different direction from the user. In another situation, the user may turn his or her head to gaze toward a different part of the virtual environment. In this situation, the virtual reality computing device may deprioritize a wind diversity location that the user appears to be turning away from, and assign a higher wind diversity score to a wind condition that the user appears to be turning to look at. In this manner, the visual experience provided to the user may be tailored both to the user's current position and gaze vector, which can provide for an improved user experience, as well as conserve processing resources of the virtual reality computing device.

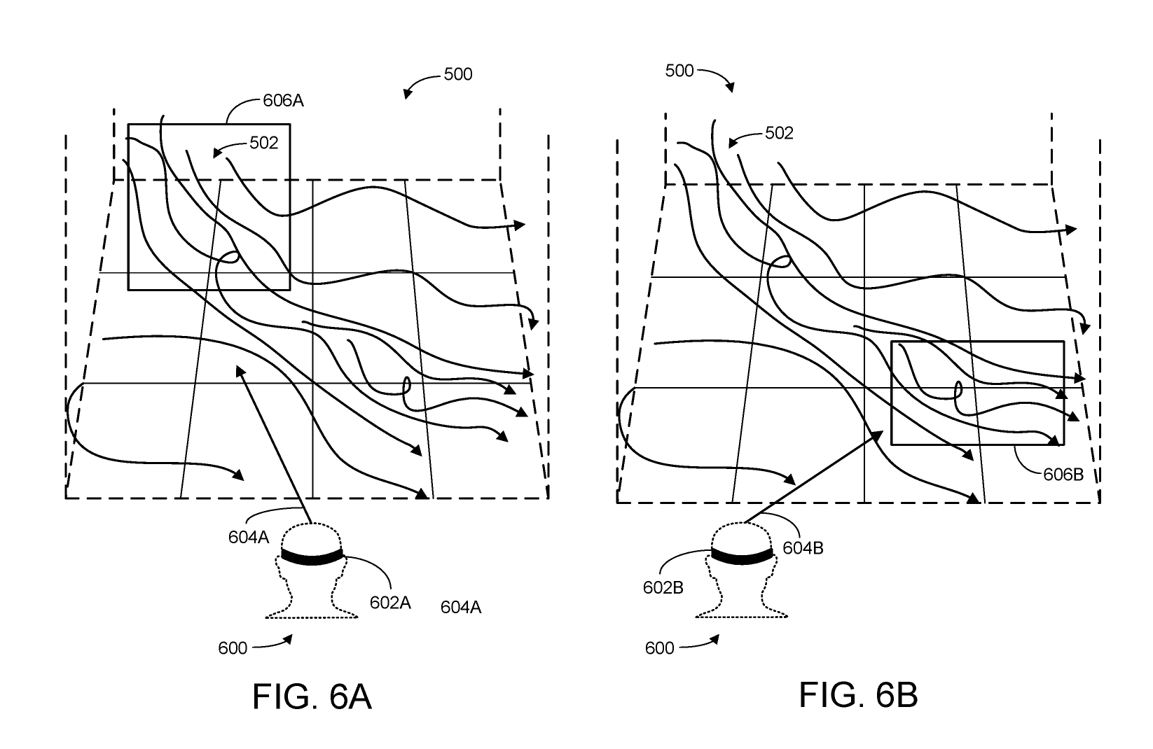

This is schematically illustrated in FIGS. 6A and 6B, which schematically illustrate a user 600 viewing virtual environment 500 from two different positions and with two different gaze vectors. Specifically, in FIG. 6A, user 600 has a position 602A and a gaze vector 604A relative to virtual environment 500. Accordingly, the virtual reality computing device has identified a wind diversity location 606A that is both in the user's FOV, and also features a high volume of wind moving at high speed, in contrast to other wind currents present in the wind source environment.

Similarly, in FIG. 6B, user 600 has a position 602B and gaze vector 604B relative to the virtual environment. In FIG. 6B, the virtual reality computing device has identified another wind diversity location 606B, which is both within the user's FOV and features a wind current exhibiting more diverse directionality than other wind currents within the wind source environment. As discussed above, wind diversity locations 606A and 606B may be identified in any suitable way, and may be based on wind speed, direction, and/or other suitable parameters, as well as the current position and gaze vector of the user.

Returning briefly to FIG. 3, at 310, method 300 includes rendering the wind data within the virtual environment as a plurality of visible wind representations, such that a differential wind effect is applied to visible wind representations rendered at the wind diversity locations. In other words, wind data at the wind diversity locations (i.e., the wind data that is anticipated to be more “interesting” to the user) may be rendered differently than wind data at other locations. It will be understood that the specific form of the visible wind representations, as well as the specific form of the differential wind effect, can vary from implementation to implementation and may in some cases be user-selectable. In an example scenario, the visible wind representations may be a plurality of particles that move throughout the virtual environment to represent real or simulated air flow. In this example, applying the differential wind effect may include increasing a density of particles rendered at the wind diversity locations. In other words, portions of the virtual environment having relatively homogeneous wind conditions may have a relatively low density of particles, while the wind diversity locations have a higher particle density, making them more easily visible to the user.

In other examples, additional or alternative visible wind representations and differential wind effects may be used. For example, when the wind data is rendered as a plurality of particles, applying the differential wind effect can include changing the size or color of the particles, in addition to or as an alternative to changing the particle density. In a further example, the wind data could be rendered as a plurality of arrows, with wind data at the wind diversity locations having an increased arrow thickness, color, density, etc.

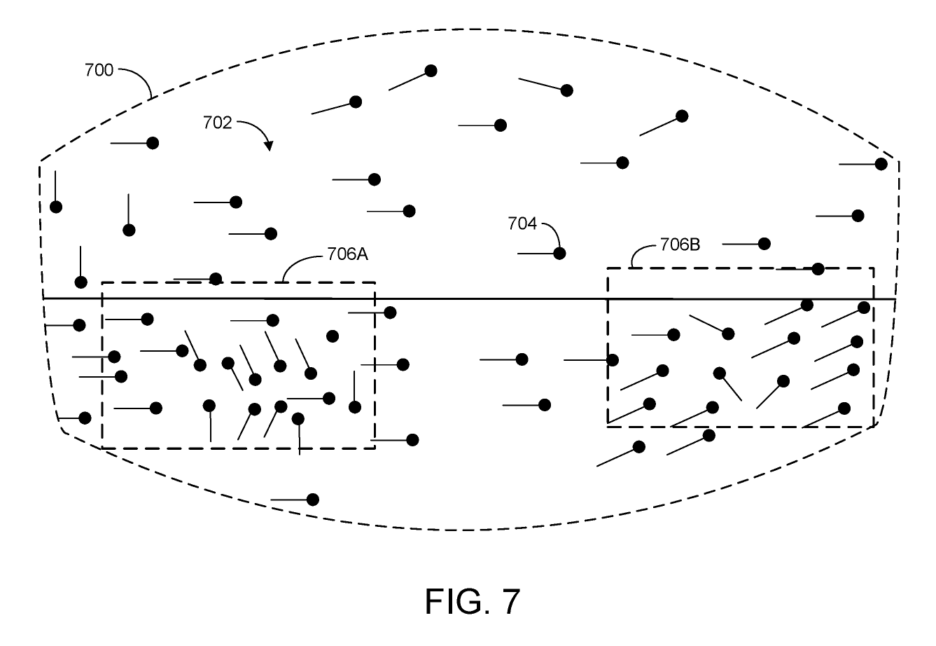

This example is illustrated in FIG. 7, which shows a field-of-view (FOV) 700 of a user looking toward a virtual environment 702. Notably, FOV includes a plurality of wind data representations 704, taking the form of particles. Each of the particles includes a tail, indicating the direction of air movement at the position of the particle. Virtual environment 700 includes two identified wind diversity locations 706A and 706B, shown in FIG. 7 as dashed boxes. As shown, particles within locations 706A and 706B are rendered with a noticeably higher density than particles located elsewhere in environment 702. In other words, wind data in the identified locations is rendered with a differential wind effect—in this case, a higher particle density. It will be understood that the dashed boxes representing the wind diversity locations need not be displayed to the user, and are only included herein as a visual aid.

In this manner, the user of the virtual reality computing device can review wind patterns spread throughout the three-dimensional space of the virtual environment, without needing to view the wind data as two-dimensional “slices” or being constrained to a top-down view. Because rendering of wind data is done based on the user's current position and gaze vector, the user may view the wind data representations from any suitable three-dimensional position by freely exploring the virtual environment. Further, in the illustrated example, less-interesting areas are rendered with a lower density of particles, allowing the user to easily identify the interesting regions within the environment, as their view of the interesting regions is not significantly occluded by less-interesting data.

FIG. 8 shows aspects of an example virtual-reality computing system 800 including a near-eye display 802. The virtual-reality computing system 800 is a non-limiting example of the virtual-reality computing devices described above, and may be usable for displaying and modifying virtual imagery. Virtual reality computing system 800 may be implemented as computing system 900 shown in FIG. 9.

The virtual-reality computing system 800 may be configured to present any suitable type of virtual-reality experience. In some implementations, the virtual-reality experience includes a totally virtual experience in which the near-eye display 802 is opaque, such that the wearer is completely absorbed in the virtual-reality imagery provided via the near-eye display 802. In other implementations, the virtual-reality experience includes an augmented-reality experience in which the near-eye display 802 is wholly or partially transparent from the perspective of the wearer, to give the wearer a clear view of a surrounding physical space. In such a configuration, the near-eye display 802 is configured to direct display light to the user's eye(s) so that the user will see augmented-reality objects that are not actually present in the physical space. In other words, the near-eye display 802 may direct display light to the user's eye(s) while light from the physical space passes through the near-eye display 802 to the user's eye(s). As such, the user's eye(s) simultaneously receive light from the physical environment and display light.

In such augmented-reality implementations, the virtual-reality computing system 800 may be configured to visually present augmented-reality objects that appear body-locked and/or world-locked. A body-locked augmented-reality object may appear to move along with a perspective of the user as a pose (e.g., six degrees of freedom (DOF): x, y, z, yaw, pitch, roll) of the virtual-reality computing system 800 changes. As such, a body-locked, augmented-reality object may appear to occupy the same portion of the near-eye display 802 and may appear to be at the same distance from the user, even as the user moves in the physical space. Alternatively, a world-locked, augmented-reality object may appear to remain in a fixed location in the physical space, even as the pose of the virtual-reality computing system 800 changes.

In some implementations, the opacity of the near-eye display 802 is controllable dynamically via a dimming filter. A substantially see-through display, accordingly, may be switched to full opacity for a fully immersive virtual-reality experience.

The virtual-reality computing system 800 may take any other suitable form in which a transparent, semi-transparent, and/or non-transparent display is supported in front of a viewer's eye(s). Further, implementations described herein may be used with any other suitable computing device, including but not limited to wearable computing devices, mobile computing devices, laptop computers, desktop computers, smart phones, tablet computers, etc.

Any suitable mechanism may be used to display images via the near-eye display 802. For example, the near-eye display 802 may include image-producing elements located within lenses 806. As another example, the near-eye display 802 may include a display device, such as a liquid crystal on silicon (LCOS) device or OLED microdisplay located within a frame 808. In this example, the lenses 806 may serve as, or otherwise include, a light guide for delivering light from the display device to the eyes of a wearer. Additionally, or alternatively, the near-eye display 802 may present left-eye and right-eye virtual-reality images via respective left-eye and right-eye displays.

The virtual-reality computing system 800 includes an on-board computer 804 configured to perform various operations related to receiving user input (e.g., gesture recognition, eye gaze detection), visual presentation of virtual-reality images on the near-eye display 802, and other operations described herein. In some implementations, some to all of the computing functions described above, may be performed off board.

The virtual-reality computing system 800 may include various sensors and related systems to provide information to the on-board computer 804. Such sensors may include, but are not limited to, one or more inward facing image sensors 810A and 810B, one or more outward facing image sensors 812A and 812B, an inertial measurement unit (IMU) 814, and one or more microphones 816. The one or more inward facing image sensors 810A, 810B may be configured to acquire gaze tracking information from a wearer's eyes (e.g., sensor 810A may acquire image data for one of the wearer's eye and sensor 810B may acquire image data for the other of the wearer's eye).

The on-board computer 804 may be configured to determine gaze directions of each of a wearer's eyes in any suitable manner based on the information received from the image sensors 810A, 810B. The one or more inward facing image sensors 810A, 810B, and the on-board computer 804 may collectively represent a gaze detection machine configured to determine a wearer's gaze target on the near-eye display 802. In other implementations, a different type of gaze detector/sensor may be employed to measure one or more gaze parameters of the user's eyes. Examples of gaze parameters measured by one or more gaze sensors that may be used by the on-board computer 804 to determine an eye gaze sample may include an eye gaze direction, head orientation, eye gaze velocity, eye gaze acceleration, change in angle of eye gaze direction, and/or any other suitable tracking information. In some implementations, eye gaze tracking may be recorded independently for both eyes.

The one or more outward facing image sensors 812A, 812B may be configured to measure physical environment attributes of a physical space. In one example, image sensor 812A may include a visible-light camera configured to collect a visible-light image of a physical space. Further, the image sensor 812B may include a depth camera configured to collect a depth image of a physical space. More particularly, in one example, the depth camera is an infrared time-of-flight depth camera. In another example, the depth camera is an infrared structured light depth camera.

Data from the outward facing image sensors 812A, 812B may be used by the on-board computer 804 to detect movements, such as gesture-based inputs or other movements performed by a wearer or by a person or physical object in the physical space. In one example, data from the outward facing image sensors 812A, 812B may be used to detect a wearer input performed by the wearer of the virtual-reality computing system 800, such as a gesture. Data from the outward facing image sensors 812A, 812B may be used by the on-board computer 804 to determine direction/location and orientation data (e.g., from imaging environmental features) that enables position/motion tracking of the virtual-reality computing system 800 in the real-world environment. In some implementations, data from the outward facing image sensors 812A, 812B may be used by the on-board computer 804 to construct still images and/or video images of the surrounding environment from the perspective of the virtual-reality computing system 800.

The IMU 814 may be configured to provide position and/or orientation data of the virtual-reality computing system 800 to the on-board computer 804. In one implementation, the IMU 814 may be configured as a three-axis or three-degree of freedom (3DOF) position sensor system. This example position sensor system may, for example, include three gyroscopes to indicate or measure a change in orientation of the virtual-reality computing system 800 within 3D space about three orthogonal axes (e.g., roll, pitch, and yaw).

In another example, the IMU 814 may be configured as a six-axis or six-degree of freedom (6DOF) position sensor system. Such a configuration may include three accelerometers and three gyroscopes to indicate or measure a change in location of the virtual-reality computing system 800 along three orthogonal spatial axes (e.g., x, y, and z) and a change in device orientation about three orthogonal rotation axes (e.g., yaw, pitch, and roll). In some implementations, position and orientation data from the outward facing image sensors 812A, 812B and the IMU 814 may be used in conjunction to determine a position and orientation (or 6DOF pose) of the virtual-reality computing system 800.

The virtual-reality computing system 800 may also support other suitable positioning techniques, such as GPS or other global navigation systems. Further, while specific examples of position sensor systems have been described, it will be appreciated that any other suitable sensor systems may be used. For example, head pose and/or movement data may be determined based on sensor information from any combination of sensors mounted on the wearer and/or external to the wearer including, but not limited to, any number of gyroscopes, accelerometers, inertial measurement units, GPS devices, barometers, magnetometers, cameras (e.g., visible light cameras, infrared light cameras, time-of-flight depth cameras, structured light depth cameras, etc.), communication devices (e.g., WIFI antennas/interfaces), etc.

The one or more microphones 816 may be configured to measure sound in the physical space. Data from the one or more microphones 816 may be used by the on-board computer 804 to recognize voice commands provided by the wearer to control the virtual-reality computing system 800.

The on-board computer 804 may include a logic machine and a storage machine, discussed in more detail below with respect to FIG. 9, in communication with the near-eye display 802 and the various sensors of the virtual-reality computing system 800.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more personal computers, virtual reality computing devices, wearable computing devices, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 implemented to perform a particular function. In some cases, a module, program, or engine may be instantiated via logic machine 902 executing instructions held by storage machine 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

In an example, a method for rendering wind data comprises: receiving wind data representing real or simulated wind conditions of a wind source environment; mapping the wind data to a plurality of locations within a virtual environment, the virtual environment being displayed by a virtual reality computing device to a user of the virtual environment; determining a position and a gaze vector of the user relative to the virtual environment; identifying, based on the position and the gaze vector of the user, wind diversity locations within the virtual environment where parameters of wind data mapped to the wind diversity locations differ from parameters of wind data mapped to other locations in the virtual environment by more than a threshold; and rendering the wind data within the virtual environment as a plurality of visible wind representations, such that a differential wind effect is applied to visible wind representations rendered at the wind diversity locations. In this example or any other example, the visible wind representations are particles. In this example or any other example, applying the differential wind effect includes increasing a density of particles rendered at the wind diversity locations. In this example or any other example, applying the differential wind effect includes changing a color of particles rendered at the wind diversity locations. In this example or any other example, applying the differential wind effect includes increasing a size of particles rendered at the wind diversity locations. In this example or any other example, the parameters used to identify the wind diversity locations are specified by the user. In this example or any other example, the wind source environment is an environment in the real world. In this example or any other example, the wind source environment is a current real-world environment of the user. In this example or any other example, the wind source environment is the virtual environment displayed by the virtual reality computing device. In this example or any other example, the virtual environment is rendered as part of a video game. In this example or any other example, the virtual environment and the wind source environment are the same size. In this example or any other example, the virtual environment is smaller than the wind source environment. In this example or any other example, the method further comprises identifying the wind diversity locations based on a distance between the position of the user and the wind diversity locations.

In an example, a virtual reality computing device comprises: a display; a logic machine; and a storage machine holding instructions executable by the logic machine to: receive wind data representing real or simulated wind conditions of a wind source environment; map the wind data to a plurality of locations within a virtual environment, the virtual environment being displayed to a user via the display; determine a position and a gaze vector of the user relative to the virtual environment; identify, based on the position and the gaze vector of the user, wind diversity locations within the virtual environment where parameters of wind data mapped to the wind diversity locations differ from parameters of wind data mapped to other locations in the virtual environment by more than a threshold; and render the wind data within the virtual environment as a plurality of visible wind representations, such that a differential wind effect is applied to visible wind representations rendered at the wind diversity locations. In this example or any other example, the visible wind representations are particles. In this example or any other example, applying the differential wind effect includes increasing a density of particles rendered at the wind diversity locations. In this example or any other example, applying the differential wind effect includes changing a color of particles rendered at the wind diversity locations. In this example or any other example, the wind source environment is an environment in the real world. In this example or any other example, the wind source environment is the virtual environment displayed by the virtual reality computing device.

In an example, a method for rendering wind data comprises: receiving wind data representing wind conditions of a real-world environment selected by a user; mapping the wind data to a plurality of locations within a virtual environment corresponding to the real-world environment, the virtual environment being displayed by a virtual reality computing device to the user; determining a position and a gaze vector of the user relative to the virtual environment; identifying, based on the position and the gaze vector of the user, wind diversity locations within the virtual environment where parameters of wind data mapped to the wind diversity locations differ from parameters of wind data mapped to other locations in the virtual environment by more than a threshold; and rendering the wind data within the virtual environment as a plurality of particles, such that a density of particles rendered at the wind diversity locations is higher than a density of particles rendered at other locations within the virtual environment.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for rendering wind data, comprising:
receiving wind data representing real or simulated wind conditions of a wind source environment;
mapping the wind data to a plurality of locations within a virtual environment, the virtual environment being displayed by a virtual reality computing device to a user of the virtual environment;
determining a position and a gaze vector of the user relative to the virtual environment;
identifying, based on the position and the gaze vector of the user, wind diversity locations within the virtual environment where parameters of wind data mapped to the wind diversity locations differ from parameters of wind data mapped to other locations in the virtual environment by more than a threshold; and
rendering the wind data within the virtual environment as a plurality of visible wind representations, such that a differential wind effect is applied to visible wind representations rendered at the wind diversity locations.

2. The method of claim 1, where the visible wind representations are particles.

3. The method of claim 2, where applying the differential wind effect includes increasing a density of particles rendered at the wind diversity locations.

4. The method of claim 2, where applying the differential wind effect includes changing a color of particles rendered at the wind diversity locations.

5. The method of claim 2, where applying the differential wind effect includes increasing a size of particles rendered at the wind diversity locations.

6. The method of claim 1, where the parameters used to identify the wind diversity locations are specified by the user.

7. The method of claim 1, where the wind source environment is an environment in the real world.

8. The method of claim 7, where the wind source environment is a current real-world environment of the user.

9. The method of claim 1, where the wind source environment is the virtual environment displayed by the virtual reality computing device.

10. The method of claim 9, where the virtual environment is rendered as part of a video game.

11. The method of claim 1, where the virtual environment and the wind source environment are the same size.

12. The method of claim 1, where the virtual environment is smaller than the wind source environment.

13. The method of claim 1, further comprising identifying the wind diversity locations based on a distance between the position of the user and the wind diversity locations.

14. A virtual reality computing device, comprising:
a display;
a logic machine; and
a storage machine holding instructions executable by the logic machine to:
receive wind data representing real or simulated wind conditions of a wind source environment;
map the wind data to a plurality of locations within a virtual environment, the virtual environment being displayed to a user via the display;
determine a position and a gaze vector of the user relative to the virtual environment;
identify, based on the position and the gaze vector of the user, wind diversity locations within the virtual environment where parameters of wind data mapped to the wind diversity locations differ from parameters of wind data mapped to other locations in the virtual environment by more than a threshold; and
render the wind data within the virtual environment as a plurality of visible wind representations, such that a differential wind effect is applied to visible wind representations rendered at the wind diversity locations.

15. The virtual reality computing device of claim 14, where the visible wind representations are particles.

16. The virtual reality computing device of claim 15, where applying the differential wind effect includes increasing a density of particles rendered at the wind diversity locations.

17. The virtual reality computing device of claim 15, where applying the differential wind effect includes changing a color of particles rendered at the wind diversity locations.

18. The virtual reality computing device of claim 14, where the wind source environment is an environment in the real world.

19. The virtual reality computing device of claim 14, where the wind source environment is the virtual environment displayed by the virtual reality computing device.

20. A method for rendering wind data, comprising:
receiving wind data representing wind conditions of a real-world environment selected by a user;
mapping the wind data to a plurality of locations within a virtual environment corresponding to the real-world environment, the virtual environment being displayed by a virtual reality computing device to the user;
determining a position and a gaze vector of the user relative to the virtual environment;
identifying, based on the position and the gaze vector of the user, wind diversity locations within the virtual environment where parameters of wind data mapped to the wind diversity locations differ from parameters of wind data mapped to other locations in the virtual environment by more than a threshold; and
rendering the wind data within the virtual environment as a plurality of particles, such that a density of particles rendered at the wind diversity locations is higher than a density of particles rendered at other locations within the virtual environment.
